(19) United States
(12) Patent Application Publication
(10) Pub. No.: US 2006/0067824 A1
(43) Pub. Date: Mar. 30, 2006

(54) Turbocharger with titanium component

(76) Inventor: Stephen John O'Hara, Zionsville, IN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/952,887

(22) Filed: Sep. 30, 2004

(51) Int. Cl. B64C 27/00

(52) U.S. Cl. 416/170 R

(57) ABSTRACT

The present disclosure includes a turbocharger. The turbocharger may include a turbine that includes titanium-aluminide and a shaft that includes titanium. A single joint connects the turbine to the shaft.

### TECHNICAL FIELD

This disclosure pertains generally to turbochargers for engines, and more particularly, to turbochargers including one or more components fabricated from titanium.

### BACKGROUND

Turbochargers can increase the power of engines by providing additional air to the engine cylinders. An exhaust-gas driven turbine connected to a compressor may be used to produce the additional air. However, turbocharger lag, which occurs while turbocharger turbines develop adequate rotational speed, can be a problem. One method for reducing turbocharger lag is to decrease the weight of the turbocharger's rotating parts, including the turbine and a shaft attached to the turbine.

Titanium-aluminide constitutes a lightweight, strong material that may be used to produce turbocharger turbines. However, the use of titanium-aluminide can complicate joining of the turbine to the turbocharger shaft, which is often made with steel. Titanium-aluminide and steel have different thermal expansion properties and may produce undesirable phase transformations at their material interfaces. Therefore, when used for applications that experience significant temperature variations, such as turbocharger components, titanium-aluminide and steel may be unsuitable for joining directly to one another.

One method of joining titanium-aluminide turbines to steel shafts is disclosed in U.S. Pat. No. 6,291,086 (hereinafter the '086 patent), which issued on Sep. 18, 2001, to Nguyen-Dinh. The method describes the use of an interlayer material disposed between a titanium-aluminide turbine and steel shaft. In the method of the '086 patent, the interlayer material is welded to both the titanium-aluminide turbine and steel shaft. Therefore, although the method of the '086 patent may provide a suitable connection between the turbine and shaft, two welds must be made and an additional material must be used, which can add significant time and cost to production. The '086 patent poses an additional problem in that the steel shaft adds significant weight to the turbocharger, which can increase turbocharger lag.

The present disclosure is directed at overcoming one or more of the problems or disadvantages existing in the prior art.

### SUMMARY OF THE INVENTION

One aspect of the present disclosure includes a turbocharger. The turbocharger includes a turbine that includes titanium-aluminide and a shaft that includes titanium. A single joint connects the turbine to the shaft.

A second aspect of the present disclosure includes a method of producing a turbocharger. This method includes providing a turbine that includes titanium-aluminide and a shaft that includes titanium. The method also includes joining the turbine to the shaft with a single joint.

A third aspect of the present disclosure is a work machine. The work machine includes a power source, an exhaust system operably connected to the power source, and a turbocharger. The turbocharger includes a turbine that includes titanium-aluminide and a shaft that includes titanium. A single joint connects the turbine to the shaft.

### BRIEF DESCRIPTION OF THE DRAWINGS

The accompanying drawings, which are incorporated in and constitute a part of this specification, illustrate exemplary embodiments of the disclosure and, together with the written description, serve to explain the principles of the disclosure. In the drawings:

FIG. 1 provides a block diagram representation of a work machine including an exemplary disclosed work machine and turbocharger of the present disclosure.

FIG. 2 provides a diagrammatic representation of an exemplary turbine and shaft of the present disclosure before being joined.

FIG. 3 provides a diagrammatic representation of an exemplary turbine and shaft of FIG. 2 after being connected by a single joint.

FIG. 4 provides a diagrammatic representation of a turbine and shaft of the present disclosure with an exemplary sleeve covering a portion of the shaft.

FIG. 5 provides a diagrammatic representation of a turbine and shaft of the present disclosure with an exemplary sleeve covering a portion of the shaft.

### DETAILED DESCRIPTION

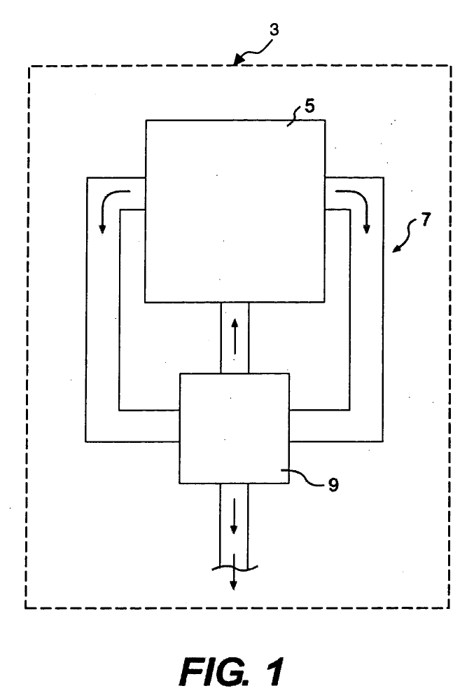

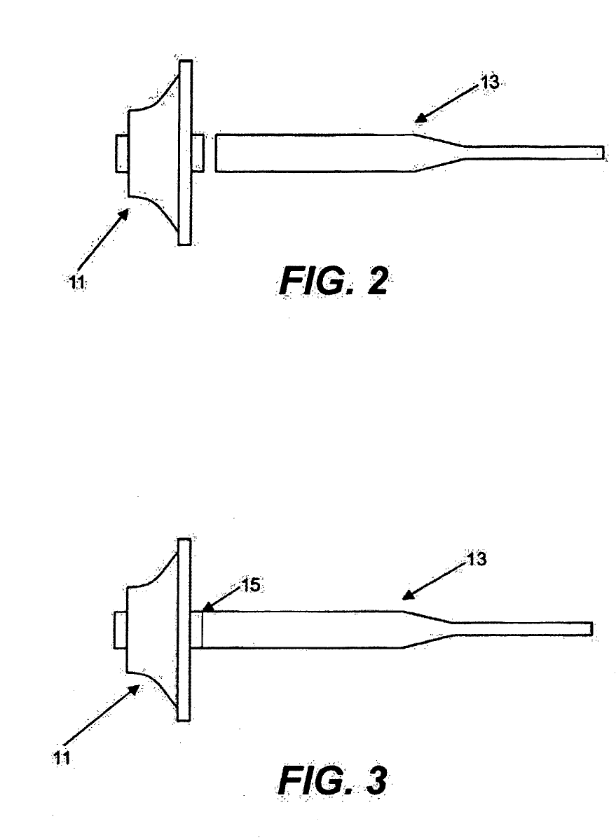

FIG. 1 provides a block diagram of a work machine 3 of the present disclosure including a power source 5, an exhaust system 7, and a turbocharger 9. Turbocharger 9 includes a turbine 11, a shaft 13, and a single joint 15, as shown in FIGS. 2-3. The turbocharger 9 may increase the power output of power source 5.

In one embodiment, turbocharger turbine 111 may include titanium-aluminide, and turbocharger shaft 13 may include titanium. Turbocharger turbine 11 and turbocharger shaft 13 may be operably connected at single joint 15, as shown in FIG. 3. Joint 15 may be made in a variety of ways. For example, gas tungsten-arc welding, gas metal-arc welding, resistance welding, laser welding, plasma arc welding, electron-beam welding, friction welding, brazing, soldering, or any other joining method may be used to form joint 15. In one embodiment, joint 15 may include a friction weld joint, an electron-beam weld joint, or a laser weld joint.

Turbine 11 and shaft 13 may be located at least partially within an exhaust system 7. The exhaust gas of exhaust system 7 may cause turbine 11 to rotate. Shaft 13, being operably connected to turbine 11, will also rotate as the rotating turbine exerts torque on shaft 13. Shaft 13 may then provide power to a compressor that may force air into power source 5. The power source 5 may be able to develop added power as a result of the forced air.

Turbine 11 can be made from a variety of materials. In one embodiment, turbine 11 may be made from one or more materials including for example, titanium-aluminide. The titanium-aluminide included in turbine 11 may be selected from a number of titanium-aluminide compositions. Titanium-aluminides that may be suitable for use with turbine 11 include, for example, gamma-TiAl, TiAl, Ti₃Al, TiAl₃, Ti-48Al-2Nb-2Cr, and Ti₂AlNb.

Shaft 13 can also be made from a variety of materials. In one embodiment, shaft 13 may be made from one or more materials including for example, titanium or alloys of titanium. The titanium included in shaft 13 may be selected from numerous refined or alloyed titanium materials. Titanium is available in a many forms, but two types of titanium materials that may be included in shaft 13 are commercially pure titanium and titanium alloys. Titanium materials may be identified by appropriate American Society for Testing and Materials (ASTM) grades, which apply to both commercially pure titanium and titanium alloys. Examples of commercially pure titanium materials are Grade 1, Grade 2, Grade 3, or Grade 4. These commercially pure materials are greater than 98% by weight titanium.

Titanium alloys that may be used in shaft 13 include, for example, alpha titanium alloys, near alpha titanium alloys, alpha-beta titanium alloys, and beta titanium alloys. In one embodiment, shaft 13 may include an alpha-beta titanium alloy. This alloy is approximately 90% titanium by weight, 6% aluminum by weight, and 4% vanadium by weight and is also known as Ti-6Al-4V or ASTM Grade 5 titanium. Other elements may be added or removed to alter the alloy's mechanical properties, corrosion resistance, thermal properties, or weldability. For example, reduced-oxygen titanium alloys may produce higher-toughness materials, and palladium or nickel additives may provide improved corrosion resistance.

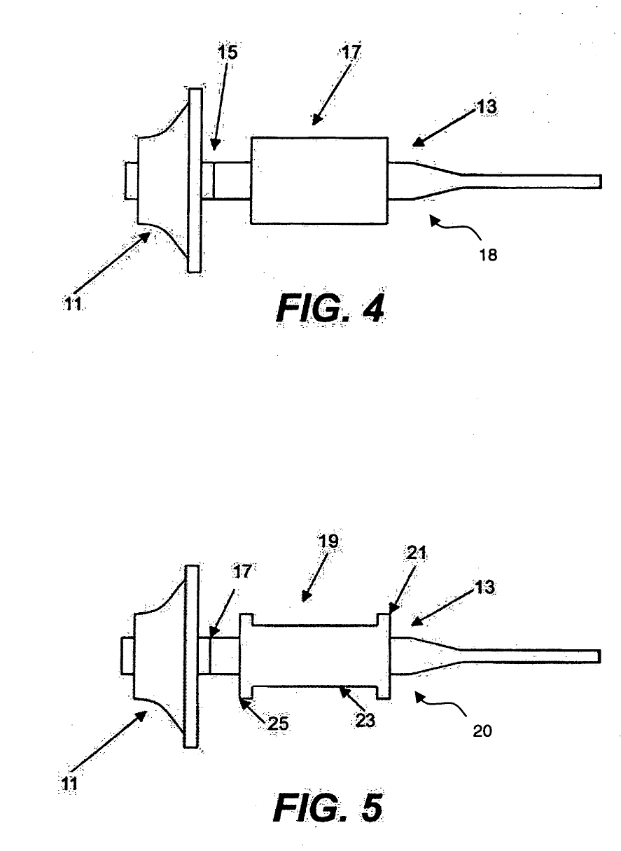

FIG. 4 illustrates another embodiment of the present disclosure. In this embodiment, a sleeve 17 may be positioned over at least a portion of turbocharger shaft 13. Sleeve 17 may be made from any material with a stiffness greater than the stiffness of titanium. For example, in one embodiment, sleeve 17 may include steel.

Sleeve 17 and shaft 13 together may form an assembly 18 that may include a selected set of mechanical properties. These properties may be a function of the material properties and dimensions of sleeve 17 and/or shaft 13. In one embodiment, sleeve 17 may be placed over shaft 13 to increase the stiffness of assembly 18.

Sleeve 17 may be made from a variety of different types of steel. In one embodiment, for example, a medium-carbon steel may be used, such as American Iron and Steel Institute 4140 steel (AISI 4140). AISI 4140 is available in a number of forms that may be incorporated into the disclosed sleeve. For example, AISI 4140 may be heat-treated using a number of different heat-treatment protocols. The heat-treatment protocol may be selected to alter the steel's hardness, toughness, stiffness, ductility, tensile strength, yield strength, machinability, or other mechanical properties.

In one embodiment, sleeve 17 may include one or more bearing surface sections that have material properties well-suited for engagement with one or more bearings. Sleeve 17 may have material properties that vary along its length including, for example, sections of increased hardness or improved wear resistance at one or more bearing surface sections. The increased hardness or wear resistance may be produced by selectively treating sections of sleeve 17 or by altering the material compositions along the length of sleeve 17. In one embodiment, sections of sleeve 17 may be treated using a protocol selected from flame hardening, induction hardening, laser beam hardening, or electron-beam hardening. In one embodiment, sleeve 17 may be made from steel, and the steel's carbon content may be increased or decreased in one or more bearing surface sections 17.

In one embodiment, shaft 13 may include bearing surface sections for engagement with one or more bearings at one or more locations along the length of shaft 13. In this embodiment, shaft 13 or specific sections of shaft 13 may be treated to increase hardness or improve wear resistance when engaging one or more bearings. In another embodiment, both sleeve 17 and shaft 13 may include one or more bearing surface sections.

FIG. 5 illustrates another embodiment of the present disclosure including turbocharger turbine 11, turbocharger shaft 13, joint 15 and a sleeve 19. Sleeve 19 has a first sleeve section 21, a second sleeve section 23, and a third sleeve section 25. The diameter of sleeve 19 at sections 21, 23, and 25 may be uniform across the sleeve's length or may be increased or decreased to conform to the shape of other components that are located near sleeve 19.

The diameter of sleeve 19 may be increased or decreased at one or more bearing surface sections in order to provide a diameter that matches one or more bearing components. In one embodiment, sleeve 19 may include bearing surface sections on both ends of sleeve 19, and the bearing surface sections may have diameters that are selected to provide space for the volume of one or more bearing components.

The diameter of sleeve 19 may also be changed in order to change the weight or mechanical properties of an assembly 20 that includes shaft 13 and sleeve 19. For example, in the embodiment of FIG. 5, first sleeve section 21 and third sleeve section 25 may be arranged as radially-oriented supporting ribs. Alternatively, first section 21 and/or third section 25 may be arranged as longitudinally-oriented supporting ribs. Providing supporting ribs in this manner may serve to provide stiffness and strength to sleeve 19 to provide a desired set of mechanical properties. Sections 21 and 25 may also be oriented in a spiral pattern with respect to sleeve 19.

### INDUSTRIAL APPLICABILITY

The present disclosure provides a lightweight turbocharger that may offer decreased lag, improved reliability and ease of manufacturing. This turbocharger may be useful in all engine types that incorporate turbochargers.

The turbocharger of the present disclosure includes a turbine that includes titanium-aluminide and is joined via a single joint to a shaft that includes titanium. Because the titanium shaft of the present disclosure does not exhibit the same joining difficulties as experienced when using a steel shaft, a single joint may be used to join the titanium shaft to the titanium aluminide turbine. The single joint of the present disclosure can reduce production time and cost and improve reliability by eliminating the need for an interlayer material.

In addition, the present disclosure provides a lighter-weight turbocharger shaft compared to steel shafts known in the prior art. Another aspect of the present disclosure is a sleeve that fits over the turbocharger shaft. The sleeve may be fabricated from a material with a stiffness greater than the shaft material in order to control the mechanical properties of the shaft and sleeve combination, and the sleeve may provide increased hardness and resistance to wear at areas of engagement with bearing components.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. A turbocharger comprising:
a turbine that includes titanium-aluminide;
a shaft that includes titanium; and
a single joint connecting said turbine to said shaft.

2. The turbocharger of claim 1, wherein said single joint is a weld joint.

3. The turbocharger of claim 2, wherein said weld joint includes at least one of a friction weld joint, an electron-beam weld joint, or a laser weld joint.

4. The turbocharger of claim 1, wherein said titanium shaft includes commercially pure titanium.

5. The turbocharger of claim 1, wherein said titanium shaft includes a titanium alloy.

6. The turbocharger of claim 1, wherein said titanium shaft includes a Ti-6Al-4V titanium alloy.

7. The turbocharger of claim 1, further including a sleeve that surrounds at least a portion of said shaft.

8. The turbocharger of claim 7, wherein said sleeve includes a material that has a stiffness greater than the stiffness of titanium.

9. The turbocharger of claim 7, wherein said sleeve includes steel.

10. The turbocharger of claim 7, wherein said sleeve includes medium-carbon steel.

11. The turbocharger of claim 7, wherein said sleeve includes an AISI 4140 steel.

12. The turbocharger of claim 7, wherein said sleeve includes one or more ribs.

13. The turbocharger of claim 7, wherein said sleeve includes one or more bearing surface sections.

14. The turbocharger of claim 1, wherein said shaft includes one or more bearing surface sections.

15. A method of producing a turbocharger comprising:
producing a turbine that includes titanium-aluminide;
producing a shaft that includes titanium; and
joining said turbine with said shaft at a single joint.

16. The method of claim 15, wherein the joining is performed by welding.

17. The method of claim 16, wherein the welding is performed by a method selected from at least one of friction welding, electron beam welding, or laser welding.

18. The method of claim 15, wherein said titanium shaft includes commercially pure titanium.

19. The method of claim 15, wherein said titanium shaft includes a titanium alloy.

20. The method of claim 15, wherein said titanium shaft includes a Ti-6Al-4V titanium alloy.

21. The method of claim 15, further including covering at least a portion of said shaft with a sleeve.

22. The method of claim 21, wherein said sleeve includes a material that has a stiffness greater than a stiffness of titanium.

23. The method of claim 21, wherein said sleeve includes steel.

24. The method of claim 21, wherein said sleeve includes medium-carbon steel.

25. The method of claim 21, wherein said sleeve includes an AISI 4140 steel.

26. The method of claim 21, wherein said sleeve includes one or more ribs.

27. The method of claim 21, wherein said sleeve includes one or more bearing surface sections.

28. The method of claim 15, wherein said shaft includes one or more bearing surface sections.

29. A work machine comprising:
a power source;
an exhaust system operably connected to the power source; and
a turbocharger disposed within the exhaust system, wherein the turbocharger includes:
a turbine that includes titanium-aluminide;
a shaft that includes titanium; and
a single joint connecting the turbine to said shaft.

30. The work machine of claim 29, wherein said single joint is a weld joint.

31. The work machine of claim 30, wherein said weld joint includes at least one of a friction weld joint, an electron-beam weld joint, or a laser weld joint.

32. The work machine of claim 29, wherein said shaft includes commercially pure titanium.

33. The work machine of claim 29, wherein said shaft includes a titanium alloy.

34. The work machine of claim 29, further including a sleeve that surrounds at least a portion of said shaft.

35. The work machine of claim 34, wherein said sleeve includes steel.

36. The work machine of claim 34, wherein said sleeve includes medium-carbon steel.

37. The work machine of claim 34, wherein said sleeve includes AISI 4140 steel.

38. The work machine of claim 34, wherein said sleeve includes one or more ribs.

39. The work machine of claim 34, wherein said sleeve includes one or more bearing surface sections.

40. The work machine of claim 29, wherein said shaft includes one or more bearing surface sections.
